(19) United States
(12) Patent Application Publication
(10) Pub. No.: US 2026/0164129 A1
(43) Pub. Date: Jun. 11, 2026

(54) IMAGE CORRECTION DEVICE, IMAGE CORRECTION METHOD, AND REMOTE OPERATION SYSTEM

(71) Applicant: Komatsu Ltd., Tokyo (JP)

(72) Inventor: Yukinori MATSUMURA, Tokyo (JP)

(21) Appl. No.: 18/723,931

(22) PCT Filed: Jan. 23, 2023
(86) PCT No.: PCT/JP2023/001841

§ 371 Date: Jun. 25, 2024

(30) Foreign Application Priority Data
Jan. 24, 2022 (JP) 2022-008826

(51) Int. Cl. H04N 23/68; E02F 9/26

(52) U.S. Cl. CPC H04N 23/682; E02F 9/264; H04N 23/6812

(57) ABSTRACT

An image correction device includes an image acquisition unit configured to acquire an image captured by an imaging device provided in a work machine which is remotely operated, a vibration information acquisition unit configured to acquire vibration information indicating a vibration of the work machine, a swing detection unit configured to detect that a swing body of the work machine is in progress of a swing, and a blur correction unit configured to perform blur correction of the image based on the vibration information and to invalidate blur correction for a yaw axis direction of the image during the swing.

### TECHNICAL FIELD

The present disclosure relates to an image correction device, an image correction method, and a remote operation system.

Priority is claimed on Japanese Patent Application No. 2022-008826, filed Jan. 24, 2022, the content of which is incorporated herein by reference.

### BACKGROUND ART

As disclosed in Patent Document 1, a technology of remotely operating a work machine is known. According to Patent Document 1, an image of a portion corresponding to a work tool is generated and displayed by using information on a position of the work tool (bucket) and information on a position of a work target obtained from information on a distance to the work target.

### CITATION LIST

### Patent Document

### Patent Document 1

Japanese Unexamined Patent Application, First Publication, No. 2016-160741

### SUMMARY OF INVENTION

### Technical Problem

In a remote operation, an operator in the operation room views an image and performs an operation, but the image may blur due to the vibration of a camera fixed to a vehicle body, which may cause the operator to feel dizzy, so that it is considered that the blur correction of the image is performed. However, in that case, the image, which should originally appear to be moved, may be displayed to appear to be stationary in the place by performing the blur correction. As a result, the operability of the operator may be decreased.

An object of the present disclosure is to provide an image correction device, an image correction method, and a remote operation system capable of suppressing a decrease in operability.

### Solution to Problem

According to a first aspect of the present disclosure, there is provided an image correction device including an image acquisition unit configured to acquire an image captured by an imaging device provided in a work machine which is remotely operated, a vibration information acquisition unit configured to acquire vibration information indicating a vibration of the work machine, a swing detection unit configured to detect that a swing body of the work machine is in progress of a swing, and a blur correction unit configured to perform blur correction of the image based on the vibration information and to invalidate blur correction for a yaw axis direction of the image during the swing.

### Advantageous Effects of Invention

According to the above aspect, the image correction device can suppress the decrease in the operability.

### BRIEF DESCRIPTION OF DRAWINGS

FIG. 1 is a schematic diagram showing the configuration of a remote operation system according to a first embodiment.

FIG. 2 is an external view of a work machine according to the first embodiment.

FIG. 3 is a schematic block diagram showing the configuration of a remote system according to the first embodiment.

FIG. 4 is a flowchart showing a display control method performed by a remote operation device according to the first embodiment.

FIG. 5 is a schematic block diagram showing the configuration of a remote system according to a second embodiment.

FIG. 6 is a flowchart showing a display control method performed by a remote operation device according to the second embodiment.

FIG. 7 is a schematic block diagram showing the configuration of a remote system according to a fourth embodiment.

FIG. 8 is a flowchart showing an output method of a captured image performed by a work machine according to the fourth embodiment.

FIG. 9 is a schematic block diagram showing the configuration of a remote system according to a fifth embodiment.

FIG. 10 is a flowchart showing an output method of a captured image performed by a work machine according to a fifth embodiment.

### DESCRIPTION OF EMBODIMENTS

### First Embodiment

### System

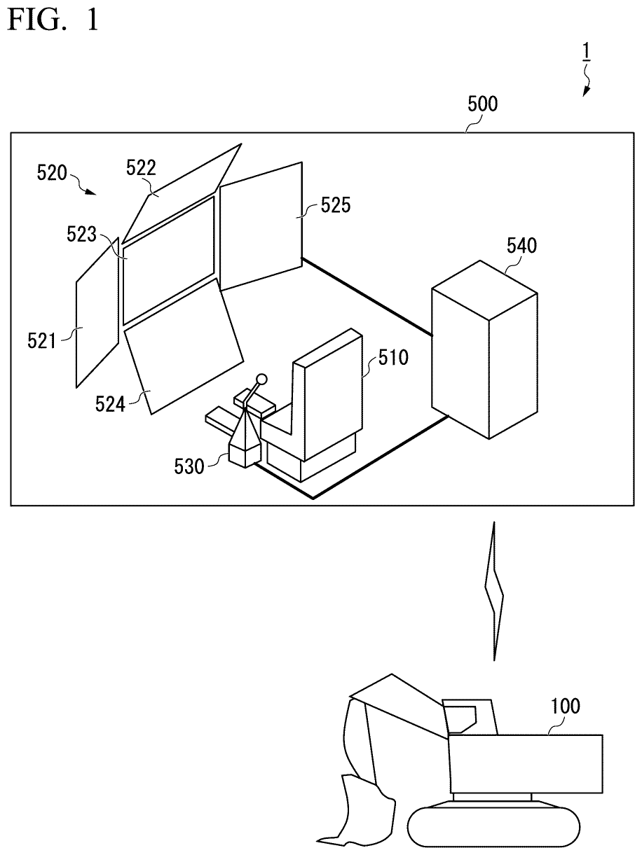

FIG. 1 is a schematic view showing the configuration of a remote operation system according to a first embodiment.

A remote operation system 1 includes a work machine 100 that operates through a remote operation, and a remote operation device 500. The work machine 100 is provided at a work site (for example, a mine or a quarry). The remote operation device 500 is provided in a remote operation room of the work site or a point away from the work site (for example, in a city or the work site). The work machine 100 and the remote operation device 500 are connected to each other via a network such as the Internet.

The remote operation system 1 is a system to operate the work machine 100 by using the remote operation device 500.

The work machine 100 operates in response to an operation signal received from the remote operation device 500.

The lever or the pedal of the operation device 530 of the remote operation room is operated by an operator, so that an operation signal of a work equipment, a swing, a travel operation, or the like is generated. The generated operation signal is transmitted to the work machine 100.

### Work Machine

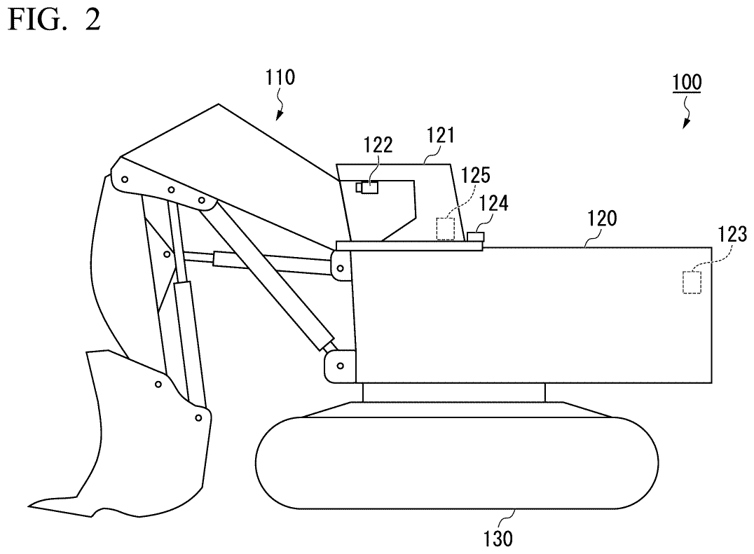

FIG. 2 is an external view of the work machine according to the first embodiment.

The work machine 100 according to the first embodiment is a hydraulic excavator. It should be noted that the work machine 100 may be a work machine, for example, a wheel loader or a bulldozer, other than the hydraulic excavator. The work machine 100 includes a work equipment 110 that is hydraulically operated, a swing body 120 that supports the work equipment 110, and an undercarriage 130 that supports the swing body 120. The undercarriage 130 is, for example, a crawler.

The swing body 120 includes a cab 121. An imaging device 122 is provided on an upper portion of the cab 121. The imaging device 122 is installed in front of and above the inside of the cab 121. The imaging device 122 captures an image (for example, a moving image) in front of the cab 121 through the windshield of the front surface of the cab 121. Exemplary examples of the imaging device 122 include an imaging device using a charge coupled device (CCD) sensor and a complementary metal oxide semiconductor (CMOS) sensor. It should be noted that the imaging device 122 may not always provided in the cab 121, and the imaging device 122 may only be provided at a position at which at least the work target of the swing body 120 and the work equipment 110 can be imaged. For example, the imaging device 122 may be provided outside the cab 121 or, may be provided in the swing body, for example. In addition, the imaging device 122 may be provided outside the work machine 100, that is, may be provided at a location different from that of the work machine 100.

The work machine 100 includes the imaging device 122, a swing speed sensor 123, a vibration sensor 124, and a control device 125.

The swing speed sensor 123 detects a rotation speed of the swing body 120 at the time of swinging. For example, the swing speed sensor 123 may be a rotary encoder.

The vibration sensor 124 measures the acceleration and the angular velocity of the swing body 120, and detects the vibration information indicating the operation (for example, a roll angle, a pitch angle, and a yaw angle) of the swing body 120 based on a measurement result. It is assumed that a relative position relationship with the imaging device 122 is fixed for the vibration sensor 124. The vibration sensor 124 is installed, for example, on a lower surface of the cab 121. The vibration sensor 124 can use, for example, an inertial measurement unit (IMU). The roll angle indicates an angle around an axis of the swing body in a front to rear direction. The pitch angle indicates an angle around an axis of the swing body in the right to left direction. The yaw angle indicates an angle around an axis of the swing body in the vertical direction. It should be noted that the vibration information can also be obtained from the acceleration or the angular velocity of the IMU without using the roll angle, the pitch angle, the yaw angle, or the like. In addition, the vibration sensor 124 may be disposed at a portion other than the swing body 120 (for example, the work equipment 110 or the like).

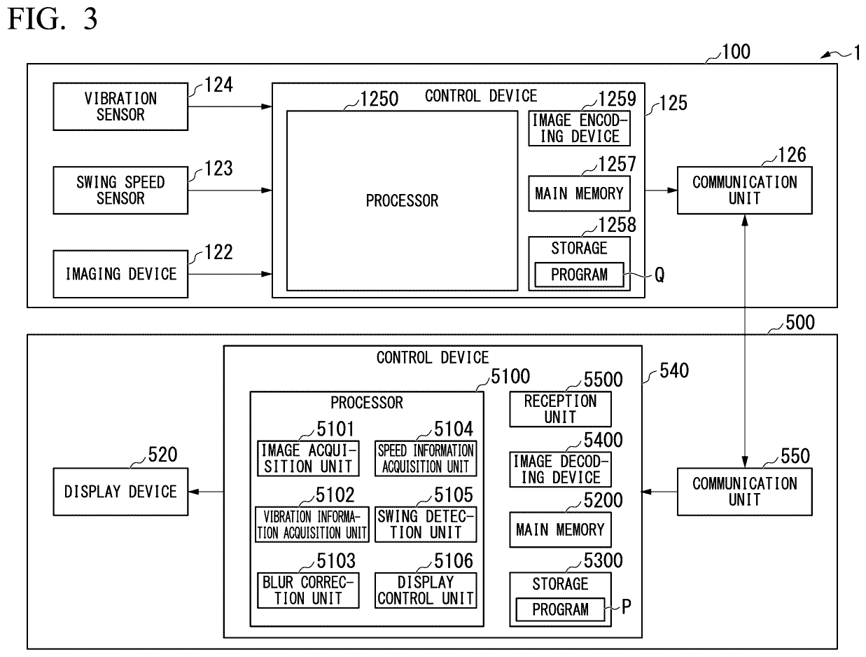

The control device 125 receives the operation signal from the remote operation device 500 via a communication unit 126 (see FIG. 3). The control device 125 drives the work equipment 110, the swing body 120, or the undercarriage 130 in response to the received operation signal.

### Remote Operation Device

As shown in FIG. 1, the remote operation device 500 includes a driver's seat 510, a display device 520, an operation device 530, and a control device 540.

The display device 520 is disposed in front of the driver's seat 510. The display device 520 is positioned in front of the operator's eyes when the operator sits on the driver's seat 510. As shown in FIG. 1, the display device 520 is configured with a display 521, a display 522, a display 523, a display 524, and a display 525 that are arranged. It should be noted that the number of displays configuring the display device 520 is not limited thereto. For example, the display device 520 may be configured with a plurality of arranged displays as shown in FIG. 1 or may be configured with one large display. In addition, the display device 520 may be configured such that an image is projected on a curved surface or a spherical surface with a projector.

The operation device 530 is disposed in the vicinity of the driver's seat 510. The operation device 530 is positioned within a range in which the operator can operate when the operator sits on the driver's seat 510. The operation device 530 includes a swing lever for swinging the swing body 120. The operation device 530 includes, for example, an electric lever and an electric pedal.

The control device 540 is an example of an image correction device. The control device 540 displays the image received from the work machine 100 on the display device 520 and transmits an operation signal representing the operation of the operation device 530 to the work machine 100.

FIG. 3 is a schematic block diagram showing the configuration of a remote system according to the first embodiment.

The control device 125 of the work machine 100 is a computer including a processor 1250, a main memory 1257, a storage 1258, and an image encoding device 1259. The storage 1258 stores a program Q. The processor 1250 reads the program Q from the storage 1258 to load the program Q in the main memory 1257 and executes processing in accordance with the program Q. The control device 125 is connected to a network via the communication unit 126. The image encoding device 1259 encodes (compresses) the image captured by the imaging device 122. It should be noted that the image encoding device 1259 may be provided separately from the control device 125.

The control device 125 associates the encoded image information with the swing speed information of the swing body 120 detected by the swing speed sensor 123 and the vibration information measured by the vibration sensor 124. As a result, each information is synchronized. The control device 125 transmits the associated information to the remote operation device 500.

The control device 540 of the remote operation device 500 is a computer including a processor 5100, a main memory 5200, a storage 5300, an image decoding device 5400, and a reception unit 5500. The storage 5300 stores a program P. The processor 5100 reads the program P from the storage 5300 to load the program P to the main memory 5200, and executes processing according to the program P. The control device 540 is connected to a network via a communication unit 550. The reception unit 5500 receives the image information, the swing speed information, and the vibration information, which are associated with each other, via the communication unit 550. The image decoding device 5400 decodes the encoded image. It should be noted that the image decoding device 5400 may be provided separately from the control device 540.

The storage 5300 has a storage area. Exemplary examples of the storage 5300 include an HDD, an SSD, a magnetic disk, a magneto-optical disk, a CD-ROM, a DVD-ROM, and a semiconductor memory. The storage 5300 may be an internal medium directly connected to a common communication line of the control device 540, or may be an external medium that is connected to the control device 540 through the interface. The storage 5300 is a non-transitory tangible storage medium.

The processor 5100 includes an image acquisition unit 5101, a vibration information acquisition unit 5102, a blur correction unit 5103, a speed information acquisition unit 5104, a swing detection unit 5105, and a display control unit 5106 by executing the program P.

The image acquisition unit 5101 acquires the image decoded by the image decoding device 5400. It should be noted that the image acquired by the image acquisition unit 5101 is an image acquired by the imaging device 122 of the work machine 100, encoded by the control device 125, and decoded by the image decoding device 5400.

The display control unit 5106 displays the image acquired by the image acquisition unit 5101 on the display device 520.

The vibration information acquisition unit 5102 acquires the vibration information of the work machine 100. The vibration information is detected by the vibration sensor 124.

The blur correction unit 5103 performs blur correction of the image displayed on the display device 520 in order to prevent the dizziness of the operator due to the remote operation. Specifically, the blur correction unit 5103 performs blur correction of the image received by the image acquisition unit 5101 in accordance with the vibration information acquired by the vibration information acquisition unit 5102. The blur correction unit 5103 performs blur correction for each of the roll axis direction, the pitch axis direction, and the yaw axis direction. Here, the blur correction based on the vibration information will be described in detail. For example, the blur correction unit 5103 performs the correction by adding the horizontal movement and the rotation to each of the plurality of captured images (each frame) obtained by continuously capturing at a high frame rate.

Specifically, the blur correction unit 5103 corrects the blur in the yaw axis direction by substituting the yaw angle into a function indicating a relationship between the yaw angle and the shift amount in the X axis direction in advance. It should be noted that the X axis direction is a horizontal direction of a screen on which the captured image is displayed, and is one of the blur directions of the captured image. The function indicating the relationship between the yaw angle and the shift amount in the X axis direction may be represented by, for example, a tangent function. In addition, the blur correction unit 5103 corrects the blur in the pitch axis direction by substituting the pitch angle into a function indicating a relationship between the pitch angle and the shift amount in the Y axis direction in advance. It should be noted that the Y axis direction is a vertical direction of a screen on which the captured image is displayed, and is one of the other blur directions of the captured image. The function indicating the relationship between the pitch angle and the shift amount in the Y axis direction may be represented by, for example, a tangent function. The blur correction unit 5103 shifts the captured image in the X axis direction and the Y axis direction by the calculated correction amount. Then, the blur correction unit 5103 corrects the blur in the roll axis direction by substituting the roll angle in a function indicating a relationship between the roll angle and the shift amount in the X axis direction, and a function indicating a relationship between the roll angle and the shift amount in the Y axis direction, in advance. The blur correction unit 5130 performs three-axis blur correction. It should be noted that the blur correction unit 5130 may perform the blur correction by any one of the yaw angle, the pitch angle, or the roll angle, or a combination of these. For example, the blur correction unit 5130 may perform blur correction for only the blur correction of the yaw angle, and may preferably perform the blur correction of the pitch angle and the yaw angle.

The speed information acquisition unit 5104 acquires the swing speed information indicating a swing speed of the work machine 100. The speed information acquisition unit 5104 acquires the swing speed information based on the detection result of the swing speed sensor 123.

The swing detection unit 5105 detects that the work machine 100 is in progress of a swing. The swing detection unit 5105 detects that the swing is in progress based on the swing speed information acquired by the speed information acquisition unit 5104. For example, when the swing speed information is acquired due to the work by the work equipment, which does not involve the swing operation, such as digging, in order not to consider that the swing is in progress, it is preferable that the swing detection unit 5105 does not detect that the swing is in progress when the swing speed is less than a threshold value. In addition, in a case of a composite operation, or the like in which the operation of the work equipment such as loading and the operation of a swing are simultaneously operated, the operation may be performed such that the swing speed is low. In such a case, in order to suppress the decrease in operability, it is preferable not to detect that the swing is in progress. Therefore, the swing detection unit 5105 detects that the swing is in progress when the swing speed is equal to or greater than a threshold value set in advance. In addition, the swing detection unit 5105 may detect that the swing is in progress by considering that the swing speed is equal to or greater than a threshold value in a case where the lever operation amount is equal to or greater than a predetermined operation amount.

The blur correction unit 5103 performs three-axis blur correction in an operation other than a swing, such as an operation of the work equipment, such as digging, during traveling, or a composite operation that is not considered as a swing. On the other hand, the blur correction unit 5103 invalidates the blur correction for the yaw axis direction of the image received by the image acquisition unit 5101 during the swing of the work machine 100. The invalidation of the blur correction for the yaw axis direction includes, for example, not performing (not executing) the blur correction for the yaw axis direction, prohibiting the blur correction, or invalidating the blur correction. In the present embodiment, the blur correction unit 5103 can prevent the blur correction in the yaw axis direction from being performed by substituting zero as the yaw angle.

The blur correction unit 5103 validates the blur correction in the yaw axis direction when the work machine 100 is not in progress of a swing. The validation of the blur correction in the yaw axis direction includes, for example, performing (executing) the blur correction in the yaw axis direction, not prohibiting the blur correction, and not invalidating the blur correction. When the operation of the work equipment is included, such as a composite operation in which the operation of the work equipment and the operation of the swing are operated at the same time, the blur correction unit 5103 may validate the blur correction of the yaw axis and execute while the blur correction of the yaw axis is included.

### Method

Here, a display control method of the captured image performed by the remote operation device 500 according to the first embodiment will be described.

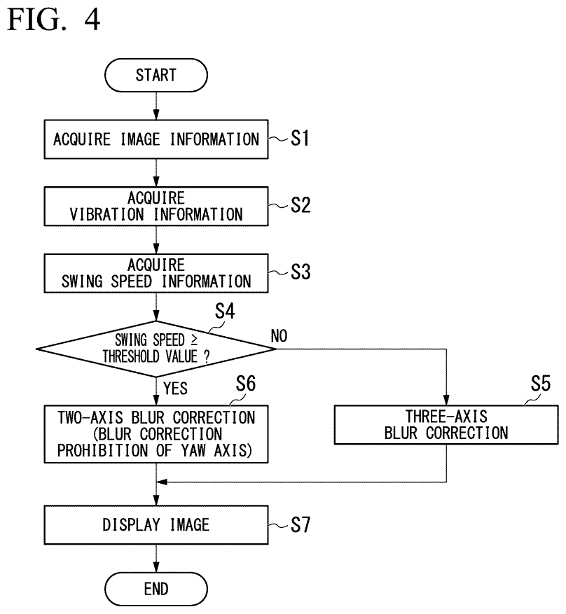

FIG. 4 is a flowchart showing a display control method performed by the remote operation device according to the first embodiment.

The control device 540 causes the image acquisition unit 5101 of the control device 540 to acquire the image information (step S1). Then, the vibration information acquisition unit 5102 acquires the vibration information (step S2). Next, the speed information acquisition unit 5104 acquires the swing speed information indicating the swing speed of the work machine 100 (step S3). It should be noted that the information acquired in the step S1 to step S3 is associated with each other.

Then, the swing detection unit 5105 determines whether or not the swing speed indicated by the swing speed information is equal to or greater than a threshold value (step S4). When the swing speed is not equal to or greater than the threshold value (step S4: NO), the blur correction unit 5103 performs three-axis blur correction (step S5), and proceeds to step S7.

On the other hand, when the swing speed is equal to or greater than the threshold value (step S4: YES), the blur correction unit 5103 performs two-axis blur correction in the pitch axis direction and the roll axis direction (step S6). Then, the display control unit 5106 displays the image for which the blur correction is performed on the display device 520 (step S7), and ends the processing shown in FIG. 4.

### Actions and Effects

As described above, according to the first embodiment, the control device 540 that performs the blur correction of the image captured by the imaging device 122 based on the vibration information of the work machine 100, invalidates the blur correction for the yaw axis direction of the image and does not perform the blur correction during the swing of the work machine 100. As a result, it is possible to suppress that the image, which should originally appear to be moved during the swing, is displayed to appear to be stationary in the place. Therefore, the discomfort of the operator during the swing can be suppressed, and the decrease in the operability of the operator can be suppressed. In addition, when the swing is not in progress, the blur correction is performed for the three-axis directions, so that the blur due to the vibration of the work machine 100 can be eliminated. Therefore, it is possible to suppress the dizziness of the operator during the work, which does not involve the swing, such as digging and soil removal.

In addition, according to the first embodiment, the control device 540 validates the blur correction in the yaw axis direction when a swing is not in progress. As a result, when the swing is not in progress, the blur correction can be performed for the three-axis directions, so that the blur due to the vibration of the work machine 100 can be eliminated. Therefore, it is possible to suppress the dizziness of the operator during the work, which does not involve the swing, such as digging and soil removal.

In addition, according to the first embodiment, the control device 540 detects that the swing is in progress based on the swing speed information indicating the swing speed of the work machine 100. As a result, it is possible to easily and accurately detect whether or not the work machine 100 is in progress of the swing.

In addition, according to the first embodiment, the control device 540 detects that the swing is in progress when the swing speed is equal to or greater than the threshold value. As a result, in a case where the swing speed information is acquired due to the work, which does not involve the swing operation, such as digging or in a case of a composite operation or the like in which the operation of the work equipment such as loading and the operation of a swing are simultaneously operated, the operation may be performed such that the swing speed is low. In such a case, since it is possible to prevent the swing from being considered to be in progress, the blur correction can be performed for the yaw axis direction. Therefore, dizziness during the work such as digging and loading can be suppressed.

### Second Embodiment

In the first embodiment, the swing detection unit 5105 detects that the swing is in progress by using the swing speed information. In the second embodiment, in addition to or instead of such a configuration, the description will be made of a case where the swing detection unit 5105 detects that the swing is in progress by using the operation amount related to the swing of the operation device 530.

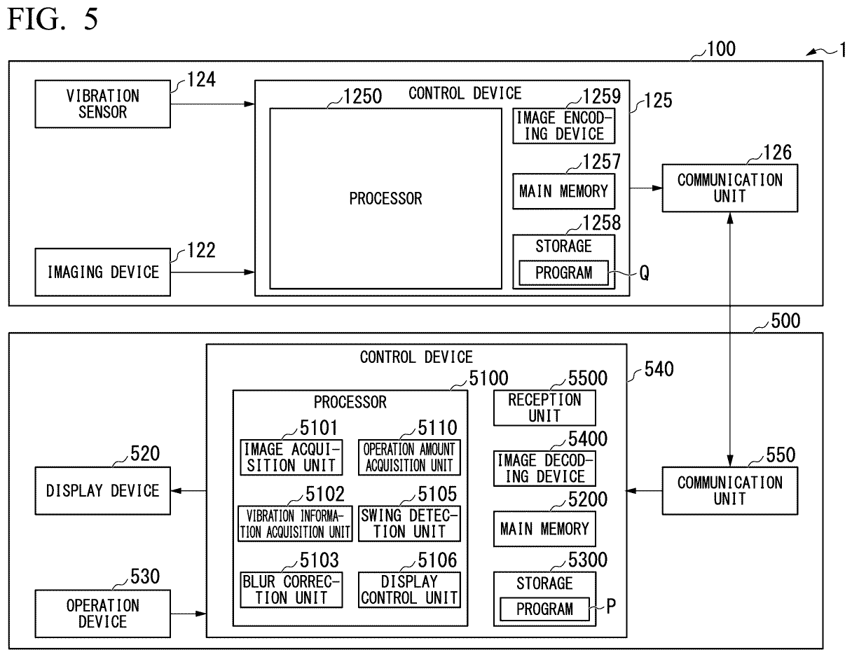

FIG. 5 is a schematic block diagram showing the configuration of a remote system according to the second embodiment.

The work machine 100 according to the second embodiment does not include the swing speed sensor 123 among the configurations of the first embodiment. In addition, the control device 540 does not include the speed information acquisition unit 5104 among the configurations of the first embodiment.

The lever provided in the operation device 530 receives the swing operation from the operator. In a case where the lever receives the swing operation, the lever outputs the operation amount of the swing indicated by the received swing operation to the control device 540.

The control device 540 includes an operation amount acquisition unit 5110. The operation amount acquisition unit 5110 acquires the operation amount of the swing outputted from the operation device 530. The swing detection unit 5105 detects that the swing is in progress based on the operation amount acquired by the operation amount acquisition unit 5110. For example, when the operation amount is acquired by the swing operation (micro-operation) in digging, loading, or the like, a swing is considered to be in progress, so that the swing detection unit 5105 does not detect that the swing is in progress when the operation amount is less than the threshold value. In other words, the swing detection unit 5105 detects that the swing is in progress when the operation amount is equal to or greater than the threshold value.

It should be noted that the control device 540 transmits the operation amount acquired by the operation amount acquisition unit 5110 to the work machine 100 via the communication unit 550. The operation amount transmitted from the remote operation device 500 is input to the control device 125 via the communication unit 126. As a result, the control device 125 causes the swing body 120 to swing at an angle in accordance with the inputted operation amount.

It should be noted that the operation amount acquisition unit 5110 is not limited to acquiring the operation amount outputted from the operation device 530 and may acquire a swing angle when the work machine 100 actually swings. To supplement specifically, the work machine 100 may transmit information associated with the image captured by the imaging device 122, the detection result of the vibration sensor 124, or a swing angle when a swing is actually performed, to the remote operation device 500. The operation amount acquisition unit 5110 may extract and acquire the swing angle from the associated information.

### Method

Here, a display control method of the captured image performed by the remote operation device 500 according to the second embodiment will be described.

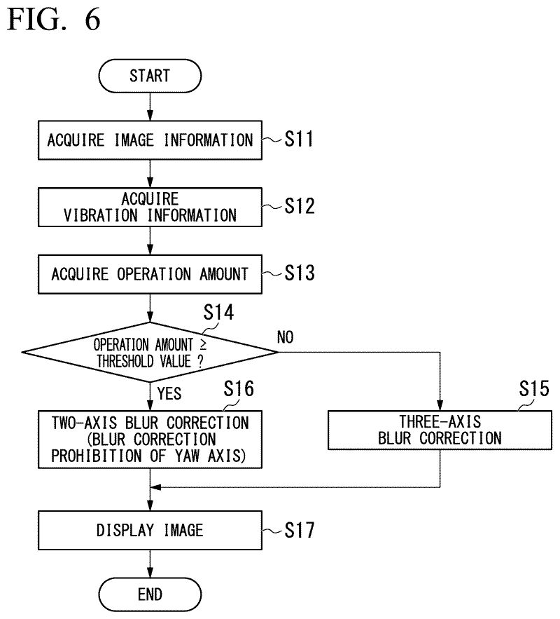

FIG. 6 is a flowchart showing a display control method performed by the remote operation device according to the second embodiment.

The image acquisition unit 5101 of the control device 540 acquires the image information (step S11). Then, the vibration information acquisition unit 5102 acquires the vibration information (step S12). Next, the operation amount acquisition unit 5110 acquires the operation amount of the swing (step S13). It should be noted that the information acquired in the step S11 to the step S13 is associated with each other.

Then, the swing detection unit 5105 determines whether or not the operation amount is equal to or greater than a threshold value (step S14). When the operation amount of the swing is not equal to or greater than the threshold value (step S14: NO), the blur correction unit 5103 performs three-axis blur correction (step S15), and proceeds to step S17.

On the other hand, when the operation amount of the swing is equal to or greater than the threshold value (step S14: YES), the blur correction unit 5103 prohibits the blur correction of the yaw axis and performs the two-axis blur correction of the pitch axis and the roll axis (step S16). Next, the display control unit 5106 displays the image for which the blur correction is performed on the display device 520 (step S17), and ends the processing shown in FIG. 6.

It should be noted that, in the second embodiment, the two-axis blur correction may be performed when the swing speed is equal to or greater than the threshold value. To supplement specifically, in the second embodiment, the work machine 100 may include the swing speed sensor 123. In addition, the control device 540 may include the speed information acquisition unit 5104. Then, in the step S14, when the operation amount of the swing is not equal to or greater than the threshold value, the speed information acquisition unit 5104 may determine whether or not the swing speed of the work machine 100 is equal to or greater than the threshold value. Furthermore, when the swing speed is equal to or greater than the threshold value, the blur correction unit 5103 may perform the two-axis blur correction.

### Actions and Effects

As described above, according to the second embodiment, the control device 540 detects that the swing is in progress based on the operation amount of the swing. As a result, since the discomfort of the operator during the swing can be suppressed, the decrease in the operability of the operator can be suppressed. In addition, it is possible to easily and accurately detect whether or not the work machine 100 is in progress of the swing.

### Third Embodiment

In the first embodiment, the blur correction is not performed in the yaw axis direction when the swing body 120 is in progress of a swing. In the third embodiment, the remote operation device 500 that does not perform the blur correction in the yaw axis direction is described regardless of whether or not the swing body 120 is in progress of a swing.

In the third embodiment, the work machine 100 does not include the swing speed sensor 123 among the configurations of the first embodiment. In addition, the control device 540 does not include the speed information acquisition unit 5104 and the swing detection unit 5105 among the configurations of the first embodiment. The blur correction unit 5103 performs blur correction for the roll axis direction and the pitch axis direction of the image received by the image acquisition unit 5101 in accordance with the vibration information acquired by the vibration information acquisition unit 5102. On the other hand, the blur correction unit 5103 does not perform the blur correction for the yaw axis direction of the image at all times.

### Method

Here, a display control method of the captured image performed by the remote operation device 500 according to the third embodiment will be described.

The image acquisition unit 5101 of the control device 540 acquires the image information. Then, the vibration information acquisition unit 5102 acquires the vibration information. Next, the blur correction unit 5103 performs the two-axis blur correction. Next, the display control unit 5106 displays the image for which the blur correction is performed on the display device 520, and ends the processing.

### Actions and Effects

As described above, according to the third embodiment, the control device 540 prevents the blur correction from being performed for the yaw axis direction of the image during the activation of the power supply, that is, always. As a result, it is possible to suppress that the image, which should originally appear to be moved during the swing, is displayed to appear to be stationary in the place with simple control. Therefore, the discomfort of the operator during the swing can be suppressed, and the decrease in the operability of the operator can be easily suppressed.

### Fourth Embodiment

In the first embodiment, the blur correction is performed on the side of the remote operation device 500. In the fourth embodiment, performing the blur correction on the side of the work machine 100 will be described.

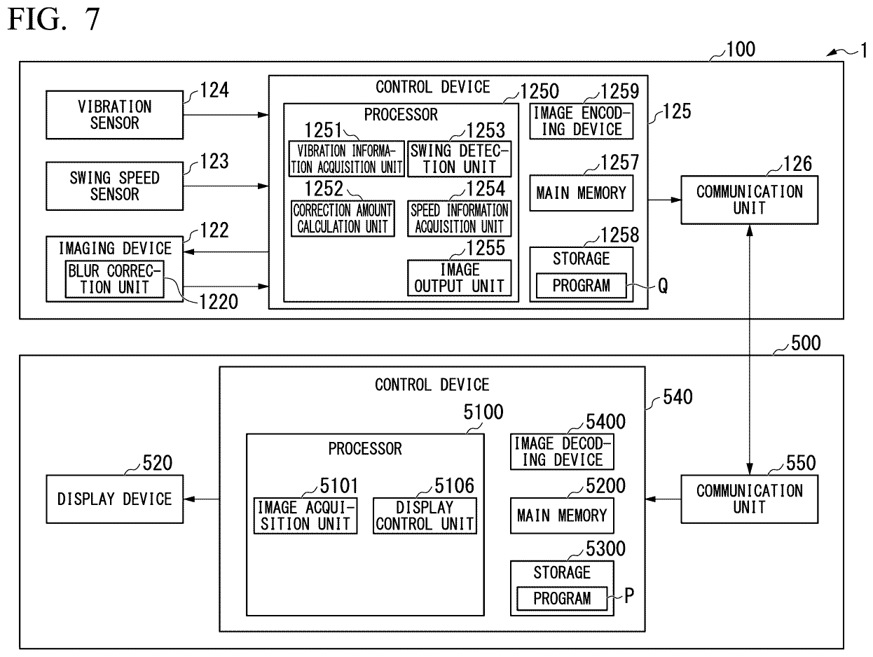

FIG. 7 is a schematic block diagram showing the configuration of a remote system according to the fourth embodiment.

The control device 125 of the work machine is an example of an image correction device.

The processor 1250 includes a vibration information acquisition unit 1251, a correction amount calculation unit 1252, a swing detection unit 1253, a speed information acquisition unit 1254, and an image output unit 1255 by executing the program Q.

The imaging device 122 includes a blur correction unit 1220.

The vibration information acquisition unit 1251 acquires the vibration information detected by the vibration sensor 124.

The blur correction unit 1220 includes a mechanism that mechanically performs the blur correction of the image in accordance with the vibration information acquired by the vibration information acquisition unit 1251. The blur correction unit 1220 is, for example, an optical type that eliminates the blur by moving the lens or the image sensor in accordance with the vibration information. Specifically, the blur correction unit 1220 includes an actuator that is driven in the yaw direction and an actuator that is driven in the pitch direction, and drives each actuator in accordance with the vibration information. Note that the blur correction unit 1220 is not limited to the optical type, and may be an exterior type that is externally attached to the imaging device 122, such as a gimbal, or an electronic type that performs a predetermined calculation on the image data received from a light reception element to perform the correction. The blur correction unit 1220 of an electronic type, for example, may correct the blur by the same method as in the blur correction unit 5103 of the first embodiment.

The correction amount calculation unit 1252 calculates the correction amount of the blur correction unit 1220. The correction amount calculation unit 1252 corrects the vibration information that occurs in the blur correction unit 1220. Specifically, an angular velocity in the yaw axis direction of the vibration information may be rewritten to zero during the swing, and the rewriting may not performed during the non-swing. The blur correction unit 1220 performs the blur correction in accordance with the vibration information corrected by the correction amount calculation unit 1252.

The swing detection unit 1253 detects that the work machine 100 is in progress of the swing. The speed information acquisition unit 1254 acquires the swing speed information indicating the swing speed based on the detection result of the swing speed sensor 123. The swing detection unit 1253 detects that the swing is in progress based on the swing speed information acquired by the speed information acquisition unit 1254. For example, the swing detection unit 5105 detects that the swing is in progress when the swing speed is equal to or greater than a threshold value.

The image output unit 1255 outputs the image captured by the imaging device 122. Specifically, the image outputted from the image output unit 1255 is input to the image encoding device 1259 to be encoded. The encoded image is output to the communication unit 126. The communication unit 126 transmits the encoded image to the communication unit 550 of the remote operation device 500.

The communication unit 550 outputs the image received from the work machine 100 to the image decoding device 5400. The image decoding device 5400 decodes the encoded image and performs outputting to the image acquisition unit 5101. The display control unit 5106 displays the image acquired by the image acquisition unit 5101 on the display device 520.

### Method

Here, an output method of the captured image performed by the work machine 100 according to the fourth embodiment will be described.

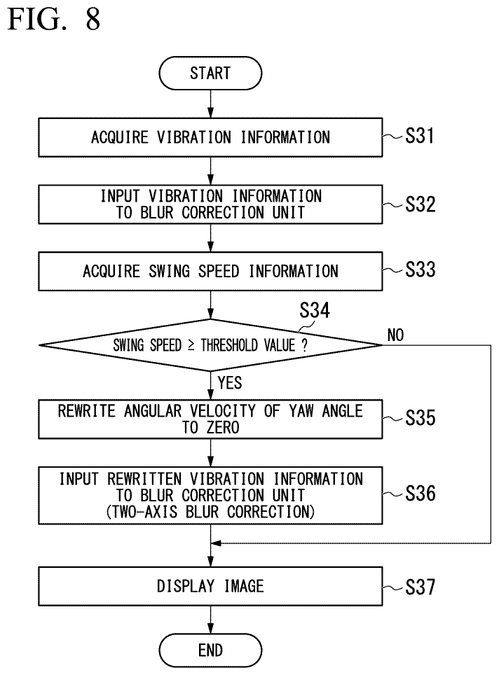

FIG. 8 is a flowchart showing an output method of a captured image performed by the work machine according to the fourth embodiment.

The vibration information acquisition unit 1251 acquires the vibration information (step S31). Then, the control device 125 inputs the vibration information to the blur correction unit 1220 (step S32). As a result, the blur correction unit 1220 performs correction in the pitch direction, the roll direction, and the yaw direction. Next, the speed information acquisition unit 1254 acquires the swing speed information indicating the swing speed of the work machine 100 (step S33).

Then, the swing detection unit 1253 determines whether or not the swing speed indicated by the swing speed information is equal to or greater than a threshold value (step S34). When the swing speed is not equal to or greater than the threshold value (step S34: NO), the correction amount calculation unit 1252 proceeds to step S37.

On the other hand, when the swing speed is equal to or greater than the threshold value (step S34: YES), the correction amount calculation unit 1252 rewrites the angular velocity of the yaw angle of the vibration information to zero (step S35). Then, the control device 125 inputs the vibration information calculated by the correction amount calculation unit 1252 to the blur correction unit 1220 (step S36). As a result, the blur correction unit 1220 performs the correction in the pitch direction and does not perform the correction in the yaw direction. Next, the image output unit 1255 outputs the image captured by the imaging device 122 (step S37), and ends the processing shown in FIG. 8.

### Actions and Effects

As described above, according to the fourth embodiment, the control device 125 controls the blur correction unit 1220 to rewrite the angular velocity of the yaw angle of the vibration information to zero during the swing of the work machine 100. As a result, it is possible to suppress that the image, which should originally appear to be moved during the swing, is displayed to appear to be stationary in the place. Therefore, the discomfort of the operator during the swing can be suppressed, and the decrease in the operability of the operator can be suppressed. In addition, when the swing is not in progress, the blur correction is performed for the three-axis directions, so that the blur due to the vibration of the work machine 100 can be eliminated. Therefore, it is possible to suppress the dizziness of the operator during the swing, which does not involve the swing, such as digging and loading.

In addition, according to the fourth embodiment, the control device 125 detects that the swing is in progress based on the swing speed information indicating the swing speed of the work machine 100. As a result, it is possible to easily and accurately detect whether or not the work machine 100 is in progress of the swing.

In addition, according to the fourth embodiment, the control device 125 detects that the swing is in progress when the swing speed is equal to or greater than the threshold value. As a result, when the swing speed is acquired by the swing operation in digging, loading, or the like, it is possible to consider that the swing is in progress, so that the blur correction can be performed also in the yaw axis direction. Therefore, dizziness during the work such as digging and loading can be suppressed.

### Fifth Embodiment

In the fourth embodiment, the swing detection unit 1253 detects that the swing is in progress by using the swing speed information. In the fifth embodiment, in addition to or instead of such a configuration, the description will be made of the work machine 100 in which the swing detection unit 1253 detects that the swing is in progress by using the operation amount related to the swing of the operation device 530.

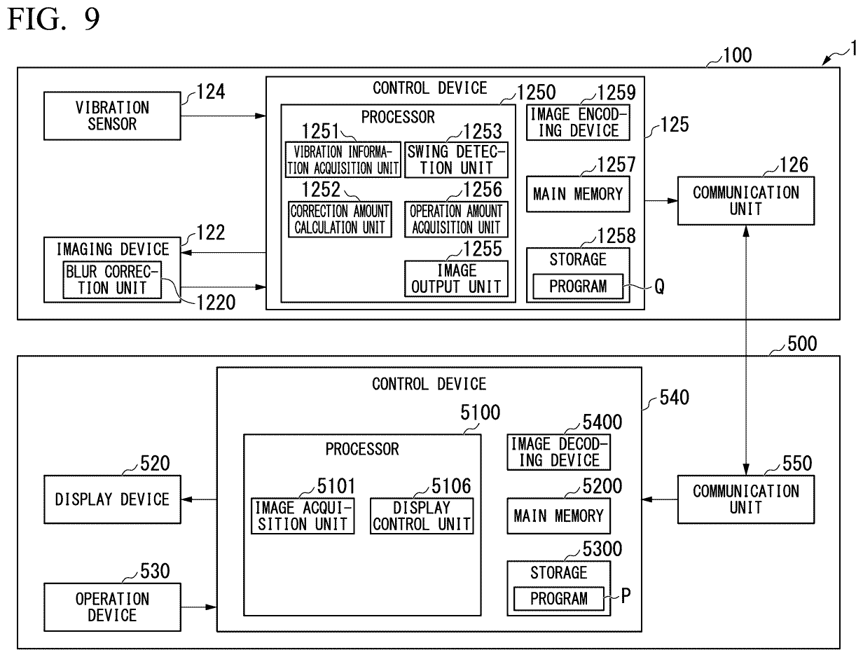

FIG. 9 is a schematic block diagram showing the configuration of a remote system according to the fifth embodiment.

In a case in which the swing operation is received, the operation device 530 outputs the received operation amount to the control device 540. The control device 540 transmits the inputted operation amount to the work machine 100 via the communication unit 550.

The control device 125 of the work machine 100 includes an operation amount acquisition unit 1256 in addition to the configuration of the fourth embodiment. The operation amount acquisition unit 1256 acquires the operation amount received by the communication unit 126. The swing detection unit 1253 detects that the swing is in progress based on the operation amount acquired by the operation amount acquisition unit 1256. It should be noted that, in the fifth embodiment, the work machine 100 does not include the swing speed sensor 123 among the configurations of the fourth embodiment. In addition, the control device 125 does not include the speed information acquisition unit 1254 among the configurations of the fourth embodiment.

### Method

Here, an output method of the captured image performed by the work machine 100 according to the fifth embodiment will be described.

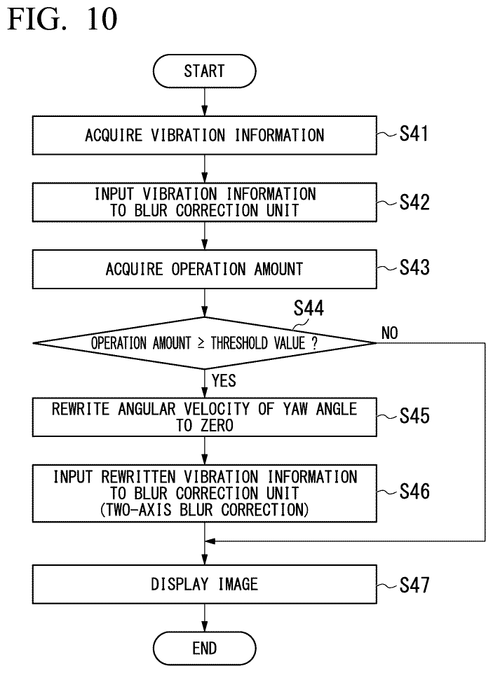

FIG. 10 is a flowchart showing an output method of the captured image performed by the work machine according to the fifth embodiment.

The vibration information acquisition unit 1251 acquires the vibration information (step S41). Then, the control device 125 inputs the vibration information to the blur correction unit 1220 (step S42). As a result, the blur correction unit 1220 performs correction in the pitch direction, the roll direction, and the yaw direction. Next, the operation amount acquisition unit 1256 acquires the operation amount of the swing (step S43).

Then, the swing detection unit 5105 determines whether or not the operation amount of the swing is equal to or greater than a threshold value (step S44). When the operation amount of the swing is not equal to or greater than the threshold value (step S44: NO), the process proceeds to step S48. On the other hand, when the operation amount of the swing is equal to or greater than the threshold value (step S44: YES), the correction amount calculation unit 1252 rewrites the angular velocity of the yaw angle of the vibration information to zero (step S45). Then, the control device 125 inputs the vibration information calculated by the correction amount calculation unit 1252 to the blur correction unit 1220 (step S46). As a result, the blur correction unit 1220 performs the correction in the pitch direction and does not perform the correction in the yaw direction.

Then, the image output unit 1255 outputs the image captured by the imaging device 122 (step S47), and ends the processing shown in FIG. 10. The output image is input to the control device 540 of the remote operation device 500 via the communication units 126 and 550, and is displayed on the display device 520.

It should be noted that, in the fifth embodiment, when the swing speed is equal to or greater than the threshold value, the angular velocity of the yaw angle of the vibration information may be rewritten to zero. To supplement specifically, in the fifth embodiment, the work machine 100 may include the swing speed sensor 123. In addition, the control device 125 may include the speed information acquisition unit 1254. Then, in the step S34, when the operation amount of the swing is not equal to or greater than the threshold value, the speed information acquisition unit 1254 may determine whether or not the swing speed of the work machine 100 is equal to or greater than the threshold value. Furthermore, when the swing speed is equal to or greater than the threshold value, the correction amount calculation unit 1252 may rewrite the angular velocity of the yaw angle of the vibration information to zero.

### Actions and Effects

As described above, according to the fifth embodiment, the control device 125 detects that the swing is in progress based on the operation amount of the swing. As a result, since the discomfort of the operator during the swing can be suppressed, the decrease in the operability of the operator can be suppressed. In addition, it is possible to easily and accurately detect whether or not the work machine 100 is in progress of the swing.

### Sixth Embodiment

In the fourth embodiment, the blur correction is not performed in the yaw axis direction when the swing body 120 is in progress of a swing. In the sixth embodiment, the work machine 100 that does not perform the blur correction in the yaw axis direction is described regardless of whether or not the swing body 120 is in progress of a swing.

In the sixth embodiment, the work machine 100 does not include the swing speed sensor 123 of the fourth embodiment. In addition, the control device 125 does not include the swing detection unit 1253 and the speed information acquisition unit 1254 of the fourth embodiment. The correction amount calculation unit 1252 always rewrites the angular velocity in the yaw axis direction of the vibration information to zero.

### Method

Here, a display control method of the captured image performed by the remote operation device 500 according to the sixth embodiment will be described.

The vibration information acquisition unit 1251 acquires the vibration information. Then, the angular velocity of the yaw angle of the vibration information is rewritten to zero. Next, the control device 125 inputs the vibration information calculated by the correction amount calculation unit 1252 to the blur correction unit 1220. As a result, the blur correction unit 1220 performs the correction in the pitch direction and the roll direction, and does not perform the correction in the yaw direction.

Then, the image output unit 1255 outputs the image captured by the imaging device 122 and ends the processing. The output image is input to the control device 540 of the remote operation device 500 via the communication units 126 and 550, and is displayed on the display device 520.

### Actions and Effects

As described above, according to the sixth embodiment, the control device 125 always rewrites the angular velocity of the yaw angle of the vibration information to zero. As a result, it is possible to suppress that the image, which should originally appear to be moved during the swing, is displayed to appear to be stationary in the place with simple control. Therefore, the discomfort of the operator during the swing can be suppressed, and the decrease in the operability of the operator can be easily suppressed.

### Another Embodiment

The embodiments have been described above in detail with reference to the drawings; however, the specific configurations are not limited to the above-described configurations, and various design changes or the like can be made. For example, the blur correction unit performs the blur correction in three axes, but may perform the two-axis blur correction of the yaw direction and the pitch direction, and may be configured to not perform the blur correction in the yaw direction during the swing in the two-axis blur correction. In another embodiment, in a vehicle using a hydraulic drive system, the vibration can be detected by a pressure fluctuation of the hydraulic actuator. Specifically, the vibration can be detected by monitoring pressure fluctuations or the like of the hydraulic cylinder and the hydraulic motor.

In the control device 540 and the control device 125 according to the above-described embodiment, a case in which each of the programs P and Q is stored in the storages 5300 and 1258, has been described, but the present disclosure is not limited thereto. For example, each of the programs P and Q may be distributed to the control device 125 or the control device 540 by the communication line. In this case, the control device 125 or the control device 540 that receives the distribution loads each of the programs P and Q to the main memories 5200 and 1257, and executes the above processing.

In addition, each of the programs P and Q may be a program for realizing some of the above-described functions. For example, each of the programs P and Q may realize the function described above, by a combination with the other programs P and Q stored in the storage 5300 and 1258 or a combination with the other programs P and Q implemented in the other devices.

In addition, each of the control device 125 and the control device 540 may include a programmable logic device (PLD) in addition to or instead of the above-described configuration. Exemplary examples of the PLD include a programmable array logic (PAL), a generic array logic (GAL), a complex programmable logic device (CPLD), and a field programmable gate array (FPGA). In this case, some of the functions realized by the processor 5100 and the processor 1250 may be realized by each of the PLDs.

In addition, each of the control device 125 and the control device 540 may include a plurality of processors 5100 and 1250, or may be configured by a plurality of computers.

In addition, in the above description, the configuration in which the control device 125 is provided in the work machine 100 has been described, but the present disclosure is not limited thereto. The control device 125 may be provided in an external computer device (for example, a cloud server). In addition, among the respective functional units (the vibration information acquisition unit 1251, the correction amount calculation unit 1252, the swing detection unit 1253, the speed information acquisition unit 1254, the image output unit 1255, the operation amount acquisition unit 1256, or the like) provided in the control device 125, all or some thereof may be provided in an external computer device. For example, among the respective functional units provided in the control device 125, all or some thereof may be provided in one computer device or may be provided in a plurality of computer devices. When each functional unit is provided in an external computer device, the remote operation device 500 may receive various types of information from the external computer device.

In addition, the same applies to the control device 540. That is, in the above description, the configuration in which the control device 540 is provided in the remote operation device 500 has been described, but the present disclosure is not limited thereto. The control device 540 may be provided in an external computer device (for example, a cloud server). In addition, among the respective functional units (the image acquisition unit 5101, the vibration information acquisition unit 5102, the blur correction unit 5103, the speed information acquisition unit 5104, the swing detection unit 5105, the display control unit 5106, the operation amount acquisition unit 5110, or the like) provided in the control device 540, all or some thereof may be provided in an external computer device. For example, among the respective functional units provided in the control device 540, all or some thereof may be provided in one computer device or may be provided in a plurality of computer devices. When each functional unit is provided in an external computer device, the display device 520 may display various types of information received from the external computer device.

### INDUSTRIAL APPLICABILITY

According to the above aspect, the image correction device can suppress the decrease in the operability.

### REFERENCE SIGNS LIST

1: Remote operation system
100: Work machine
122: Imaging device
123: Swing speed sensor
124: Vibration sensor
125: Control device
500: Remote operation device
510: Driver's seat
520: Display device
530: Operation device
540: Control device
1220: blur correction unit
1251: Vibration information acquisition unit
1252: Correction amount calculation unit
1253: Swing detection unit
1254: Speed information acquisition unit
1255: Image output unit
1256: Operation amount acquisition unit
5101: Image acquisition unit
5102: Vibration information acquisition unit
5103: blur correction unit
5104: Speed information acquisition unit
5105: Swing detection unit
5106: Display control unit
5110: Operation amount acquisition unit

1. An image correction device comprising:
an image acquisition unit configured to acquire an image captured by an imaging device provided in a work machine which is remotely operated;
a vibration information acquisition unit configured to acquire vibration information indicating a vibration of the work machine;
a swing detection unit configured to detect that a swing body of the work machine is in progress of a swing; and
a blur correction unit configured to perform blur correction of the image based on the vibration information and to invalidate blur correction for a yaw axis direction of the image during the swing.

2. The image correction device according to claim 1, wherein
the blur correction unit validates the blur correction in the yaw axis direction when the swing is not in progress.

3. The image correction device according to claim 1, further comprising:
a speed information acquisition unit configured to acquire swing speed information indicating a swing speed of the work machine, wherein
the swing detection unit detects that the swing is in progress based on the swing speed information.

4. The image correction device according to claim 3, wherein
the swing detection unit detects that the swing is in progress when the swing speed is equal to or greater than a threshold value.

5. The image correction device according to claim 1, further comprising:
an operation amount acquisition unit configured to acquire an operation amount related to a swing of an operation unit provided in the work machine, wherein
the swing detection unit detects that the swing is in progress based on the operation amount.

6. An image correction device comprising:
an image acquisition unit configured to acquire an image captured by an imaging device provided in a work machine which is remotely operated;
a vibration information acquisition unit configured to acquire vibration information indicating a vibration of the work machine; and
a blur correction unit configured to invalidate blur correction for a yaw axis direction of the image based on the vibration information.

7. An image correction method comprising:
a step of acquiring an image captured by an imaging device provided in a work machine which is remotely operated;
a step of acquiring vibration information indicating a vibration of the work machine;
a step of detecting that a swing body of the work machine is in progress of a swing; and
a step of performing blur correction of the image based on the vibration information and invalidating blur correction for a yaw axis direction of the image during the swing.

8. A remote operation system comprising:
an image acquisition unit configured to acquire an image captured by an imaging device provided in a work machine which is remotely operated;
a vibration information acquisition unit configured to acquire vibration information indicating a vibration of the work machine;
a swing detection unit configured to detect that a swing body of the work machine is in progress of a swing; and
a blur correction unit configured to perform blur correction of the image based on the vibration information and to invalidate blur correction for a yaw axis direction of the image during the swing.
